(19) United States
(12) Patent Application Publication
(10) Pub. No.: US 2011/0181709 A1
(43) Pub. Date: Jul. 28, 2011

(54) SYSTEMS AND METHODS FOR ENDOSCOPIC IMAGING WITH MONOCHROMATIC DETECTOR

(75) Inventors: George Wright, Dove Canyon, CA (US); Lonnie Hoyle, Mission Viejo, CA (US); Kais Almarzouk, Tustin, CA (US)

(73) Assignee: INTEGRATED ENDOSCOPY, INC., Rancho Santa Margarita, CA (US)

(21) Appl. No.: 12/975,062

(22) Filed: Dec. 21, 2010

Related U.S. Application Data
(60) Provisional application No. 61/289,233, filed on Dec. 22, 2009.

(51) Int. Cl. H04N 7/18

(52) U.S. Cl. 348/65; 348/E07.085

(57) ABSTRACT

Disclosed are systems and methods for obtaining color endoscopic images with a monochromatic detector. In certain embodiments, such a monochromatic detector can provide beneficial features such as high resolution capability. In certain embodiments, a number of different color light sources can be controlled separately so as to allow sequential illumination of an object with the different color lights. Images obtained from such sequential illumination can be combined to yield a color image. Various configurations and examples for facilitating such a process are disclosed.

### CROSS-REFERENCE TO RELATED APPLICATIONS

The present application claims priority from U.S. patent application Ser. No. 61/289,233, filed Dec. 22, 2009, the content of which is incorporated herein by reference in its entirety.

### BACKGROUND

1. Field of the Invention

The present disclosure relates generally to medical devices and methods, and more particularly, to endoscopes and similar devices for imaging objects inside a body.

2. Description of the Related Art

Endoscopes typically include a tube dimensioned to be insertable into a body. Once inserted to a region of interest, light is provided to illuminate an object to be viewed. The illuminated object is then detected and imaged by a detector.

### SUMMARY

In certain embodiments, the present disclosure relates to a method for operating an endoscope. The method includes providing a plurality of different color light sources, and activating the light sources in sequence such that an object being imaged is provided with a sequence of different color illumination. The method further includes obtaining an image of the object during at least a portion of each of the sequence of different color illumination. The method further includes combining the images so as to yield a combined image.

In certain embodiments, the present disclosure relates to an endoscope system. The system includes a probe configured to be insertable into a body. The system further includes a plurality of light sources configured and disposed relative to the probe so as to provide a sequence of different color illumination from the probe to an object inside the body. The system further includes an assembly of optical elements configured and disposed relative to the probe so as to form images of the object during the sequence of different color illumination. The system further includes a detector configured to detect the images and generate signals representative of the detected images. The system further includes a processor configured so as to control sequential activation of the plurality of light sources so as to yield the sequence of different color illumination. In certain embodiments, the processor is further configured so as to control the detector such that the images are detected sequentially.

### BRIEF DESCRIPTION OF THE DRAWINGS

FIG. 1 shows a block diagram of an endoscope system having various components configured to facilitate one or more features of the present disclosure;

FIG. 2 shows that in certain embodiments, an endoscope can be coupled electrically and/or optically to a separate component via a cable so as to facilitate transfer of, for example, power and/or signals associated with images detected by the endoscope;

FIG. 3 shows that in certain embodiments, an endoscope can be coupled to a separate component without a cable so as to facilitate transfer of, for example, control signals and/or signals associated with images detected by the endoscope;

FIG. 4 shows that in certain embodiments, the endoscope system of FIG. 1 can include a plurality of different colored light sources and a monochromatic detector so as to facilitate obtaining and combining of a plurality of single-color images;

FIG. 5 shows that in certain embodiments, the different colored light sources of FIG. 4 can include red (R), green (G), and blue (B) light-emitting diodes (LEDs) whose operations can be controlled separately;

FIG. 6 shows an example of how the example RGB LEDs of FIG. 5 can be activated in sequence to facilitate sequential single-colored illumination;

FIG. 7 shows a block diagram of an example readout scheme configured to facilitate acquisition of detected signals resulting from the single-colored illumination;

FIG. 8 shows an example of a readout timing sequence in the context of the example illumination sequence of FIG. 6;

FIG. 9 shows another example of a readout timing sequence in the context of the example illumination sequence of FIG. 6;

FIG. 10 shows that in certain embodiments, one or more operating parameters of one or more of the plurality of colored light sources can be adjusted such that lights from the colored light sources can combine to yield or approximate a desired intensity distribution;

FIG. 11 shows an example process that can be implemented to obtain single-colored images resulting from adjusted single-colored illumination;

FIG. 12 shows an example process that can be implemented to approximate a desired color distribution by using light sources including R, G, and B colored light sources;

FIG. 13 shows a more specific example of the process of FIG. 12, where the light sources are LEDs, and where intensities of the LEDs can be adjusted to obtain the desired color distribution; and

FIG. 14 shows that in certain embodiments, a process can be implemented to adjust one or more of the single-colored images so as to yield a desired color characteristic in the combined image.

These and other aspects, advantages, and novel features of the present teachings will become apparent upon reading the following detailed description and upon reference to the accompanying drawings. In the drawings, similar elements have similar reference numerals.

### DETAILED DESCRIPTION OF CERTAIN EMBODIMENTS

The present disclosure relates generally to medical devices and methods, and in some embodiments, to endoscopes and other devices for viewing and/or imaging objects inside a body. For the purpose of description, a “body” can be that of a human or non-human animal, and can also be that of a living or non-living animal.

Endoscopes are useful tools for viewing and/or imaging objects inside a cavity of a body. Such a cavity can include, for example, a portion of a blood vessel or a gastrointestinal tract. Additional details about endoscopes and components therein can be found in, for example, U.S. patent application Ser. No. 11/099,435 (U.S. Publication No. 2006-0041193) which is incorporated herein by reference in its entirety.

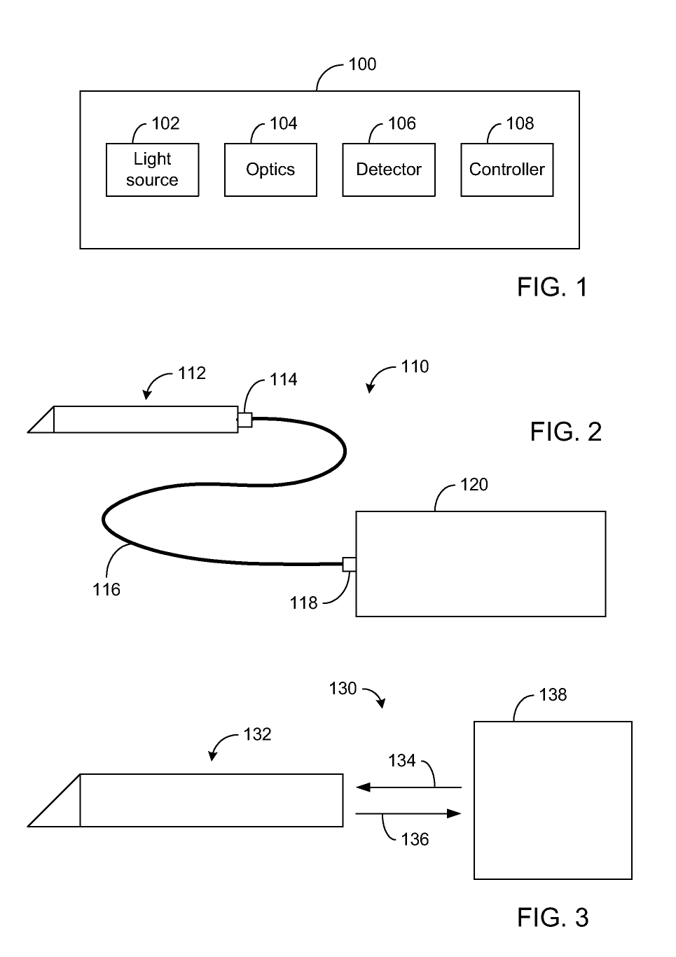

As described herein, the present disclosure provides one or more features that can allow obtaining of high-resolution endoscopic images without additional complexities and costs typically associated with such performance. FIG. 1 shows that in certain embodiments, an endoscope system 100 can include various components that provide functionalities to enhance performance features such as high-resolution imaging capability.

The system 100 can include a light source component 102 for providing light to a region of interest so as to allow imaging of one or more objects in the region. For the purpose of description, “light” can include visible light as commonly understood, as well as wavelength ranges typically associated with ultra-violet and/or infrared radiation. Non-limiting examples of the light source component 102 are described herein in greater detail.

For the purpose of description herein, various components are sometimes referred to as “monochromatic” and “single-color.” Also, certain colors are referred to as, for example, “red,” “green,” and “blue.” Typically, an intensity distribution of a given colored light can have certain shape and width, and such width can extend to a region typically associated with another color. Thus, terms such as “single-color” can mean predominantly of that color, with the understanding that there may be components associated with other color(s). In the context of the present disclosure, usages of terms such as the foregoing examples are not intended to, and in fact do not, restrict or limit the various concepts described herein.

The system 100 can also include an optics component 104 configured to form images of the illuminated objects. For the purpose of description, it will be understood that such images can result from reflection of light from the object, as well as induced light emission such as fluorescence. Non-limiting examples of the optics component can be found in the herein-mentioned U.S. patent application Ser. No. 11/099,435 which is incorporated herein by reference in its entirety.

The system 100 can also include a detector component 106 configured to detect and capture images formed by the optics component 104. Such a detector can be, for example, a segmented detector such as a charge-coupled-device (CCD) or a complementary-metal-oxide-semiconductor (CMOS) detector. Such a detector can include a detector array with an array of detector elements.

In certain embodiments as described herein, the detector 106 can be a monochromatic detector (also sometimes referred to as a black-and-white detector). As generally understood, monochromatic detectors can provide certain performance advantages over color detectors. For example, certain monochromatic detectors can have significantly higher resolution capabilities than similarly-priced color counterparts. In certain embodiments, the detector 106 can be a color detector that detects single-color images resulting from single-color illumination.

The system 100 can also include a controller component 108 configured to provide one or more controlling functionalities of one or more components of the system 100. In certain optional embodiments, the controller component 108 can include a processor, and optionally an associated tangible storage medium, configured to perform or induce performance of such functions.

FIGS. 2 and 3 show that the endoscope system 100 (FIG. 1) can be embodied in a number of ways. For example, FIG. 2 shows that in certain embodiments, a system 110 can include an endoscope probe 112 physically coupled to a separate component 120 via a cable assembly 116.

The probe 112 can include, for example, a light source assembly disposed at or near its distal end. The probe 112 can also include an optics assembly and a detector to facilitate formation and detection of images of illuminated objects. For such an example endoscope configuration, the cable assembly 116 can include an electrical power supply cable for powering the light source and detector, and a signal cable for transferring signals to and from the same. The electrical power can be supplied by a power source that is either part of, or facilitated by, the separate component 120. The separate component 120 can also include a processor for providing controlling and/or signal processing functionalities. In certain embodiments, the cable assembly 116 can be coupled to one or both of the probe 112 and separate component 120 via connectors (114 and 118) in known manners. In certain embodiments, a detector can also be disposed at proximal end of the component 120 with relay lenses or fiber optic bundle in the cable assembly 116.

In another example, FIG. 3 shows that in certain embodiments, a system 130 can include an endoscope probe 132 configured to communicate with a separate component 138 via a communication link such as a wireless link. In such a system, the probe 132 can be powered by, for example, a battery such that the power connection of FIG. 2 is not needed.

Further, signal transferring functionality can be provided wirelessly. For example, control signals for the light source and/or the detector can be transmitted wirelessly (depicted as arrow 134) from the separate component 138 to the probe 132. Similarly, signals from the detector can be transmitted to the separate component 138 wirelessly (depicted as arrow 136).

A number of other configurations are also possible. For example, some combination of connectivities shown in FIGS. 2 and 3 can be implemented.

As described herein, an endoscopic system can be configured so that a plurality of single-color images can be obtained using a monochromatic detector. Such single-color images can be combined so as to yield a color image. In certain embodiments, such a color image can benefit from relatively high-resolution capability associated with some monochromatic detectors.

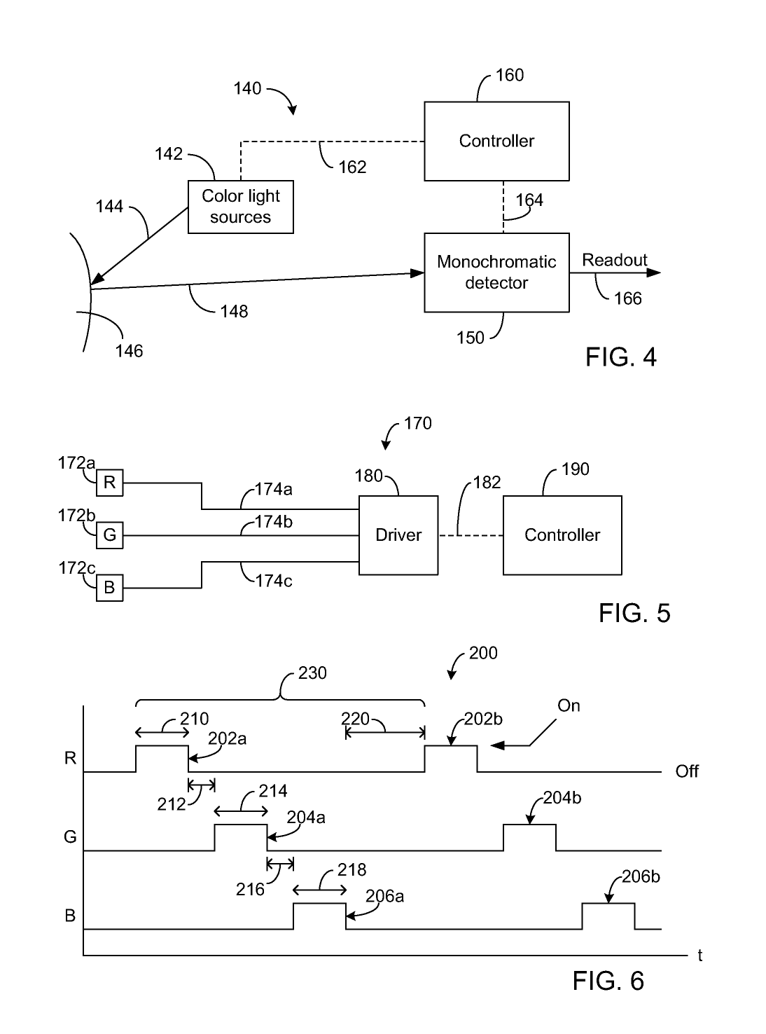

FIG. 4 shows an example situation where an endoscope system 140 is being utilized. An assembly 142 of a plurality of color light sources is depicted as illuminating (arrow 144) an object 146. Reflected light and/or induced light emission (arrow 148) is shown to be detected by a monochromatic detector 150.

As shown, operation of the light sources 142 and the detector 150 can be controlled (depicted as lines 162 and 164) by a controller 160. The controller 160 can also facilitate reading out of signals (depicted as arrow 166) from the detector 150.

As described herein, controlling of the light sources 142 and the detector 150 can be performed such that a single monochromatic detector images a number of single-colored images. Such a feature can provide significant benefits in terms of cost savings as well as simplicity in design.

In certain embodiments, such single-colored images can be obtained using a monochromatic detector and by illuminating an object with different colored lights in sequence. Examples of such sequential illumination are described herein in greater detail.

FIG. 5 shows an example of how the light sources can be controlled as described in reference to FIG. 4. In certain embodiments, an illumination configuration 170 can include a driver 180 under control (line 182) of a controller 190. The driver 180 can be, for example, an LED driver that provides driving signals (e.g., 174a, 174b, 174c) to different colored LEDs (e.g., R, G, B) 172a, 172b, 172c. Although three example colors (R, G, B) of LED are discussed for the purpose of description, it will be understood that more or less colors can be utilized.

FIG. 6 shows an example 200 of how the LEDs can be controlled. Such control signals can be formatted appropriately and provided to the LED driver (180 in FIG. 5) from the controller (190). A control sequence for the example red LED is indicated as “R,” and can include a sequence of activation pulses 202a, 202b, etc. As indicated, a high state can correspond to an “ON” state for the red LED, and a low state can correspond to an “OFF” state. Duration time for the ON state (arrow 210) and other cycle parameter(s) can be adjusted to achieve a desired result.

A control sequence for the example green LED is indicated as “G,” and can include similar sequence of activation pulses 204a, 204b, etc. Similar to the red LED, duration time for the ON state (arrow 214) and other cycle parameter(s) can be adjusted.

In certain embodiments, the ON pulse for one of the colors (e.g., green) can be provided after a delay 212 from the OFF time of another color (e.g., red). Such a delay can provide, for example, sufficient time for one LED to transition to the OFF state prior to illumination by the next LED.

A control sequence for the example blue LED is indicated as “B,” and can include similar sequence of activation pulses 206a, 206b, etc. Similar to the green LED, duration time for the ON state (arrow 218) and other cycle parameter(s) can be adjusted. Similar to the red-to-green delay 212, a green-to-blue delay 216 can be provided.

As shown in FIG. 6, a delay 220 can be provided from the blue LED's OFF time to the next ON time of the red LED. As shown, time between the two pulses for a given color can define a cycle period 230. Such cycles can be repeated so as to provide repeated sequences of RGB illumination and image generation.

FIG. 6 also shows an example of a sequence 232 of detector activations. In certain embodiments, such activations can be facilitated by a shutter, and thus, the activation sequence 232 is indicated as “S.” It will be understood that other activation methods (e.g., shutter-less activation) can be implemented.

As shown, the shutter can be opened during a period that overlaps with each of the ON states of the colored illumination. For example, ON state 234a of the detector corresponds to the ON state 202a of the red LED, ON state 234b of the detector corresponds to the ON state 204a of the green LED, and so on.

In certain embodiments, the duration and/or timing of the detector activations can be controlled. For example, durations of activations can be controlled for exposure adjustments. In another example, duration of the detector's ON state corresponding to a particular color illumination can be adjusted so as to allow the detector to receive more or less of the particular color light. Such adjustments can be utilized to control the amounts of different colored lights provided to the detector. As described herein, combinations of such single-colored lights having different intensities can yield desired color effects.

Other configurations of detector activation are also possible. For example, the detector can remain in an ON state, and “shuttering” can be achieved by modulation of the single-colored illumination. In another example, the detector can remain ON during a frame (red, green, blue illumination in the example of FIG. 6), be turned OFF during a delay period between frames, and be turned back ON for the next frame.

In certain embodiments, various timings of the foregoing example can be adjusted so as to yield or approximate real-time imagery capability. For example, if the cycle period 230 is made sufficiently short and resulting images are combined in a timely manner, then repetition of such cycles can yield or approximate video images in color.

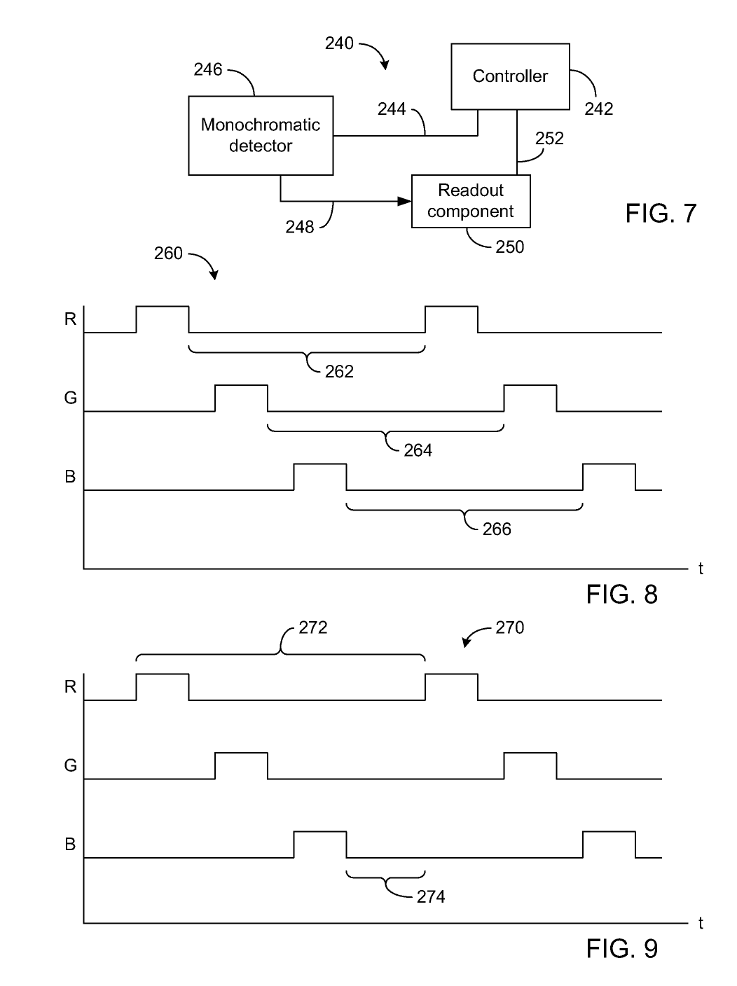

Single-color images detected and obtained in the foregoing example manner can be read out and processed in a number of ways. FIG. 7 shows an example readout configuration 240 where signals from a monochromatic detector 246 can be read out (arrow 248) by a readout component 250. In certain embodiments, the detector 246 and the readout component 250 can be under control (lines 244 and 252) of a controller 242.

Reading out of signals from the detector 246 can be achieved in a number of ways. In certain embodiments, signals from the detector can be transferred to a buffer relatively quickly, and such buffered signals can be processed and/or read out in a number of ways.

FIG. 8 shows an example 260 where signals (e.g., buffered signals) can be read out for each LED between that LED's ON pulses. For example, the red LED can be read out during its OFF period 262. Similarly, the green LED can be read out during its OFF period 264. Similarly, the blue LED can be read out during its OFF period 266.

FIG. 9 shows another example 270 where signals for all of the LEDs can be read out together for a given cycle 272. Thus, signals corresponding to red, green, and blue LEDs can be read out during a period at the end of the current cycle 272. Other readout schemes can also be implemented.

In certain embodiments, controlling of the LEDs (such as via the example control configuration of FIG. 5) can include adjustments of output intensities of one or more of the LEDs. Such adjustments can be utilized to yield a combination of colored lights having a desired intensity profile. Such a desired intensity profile can approximate, for example, a profile associated with a selected light source.

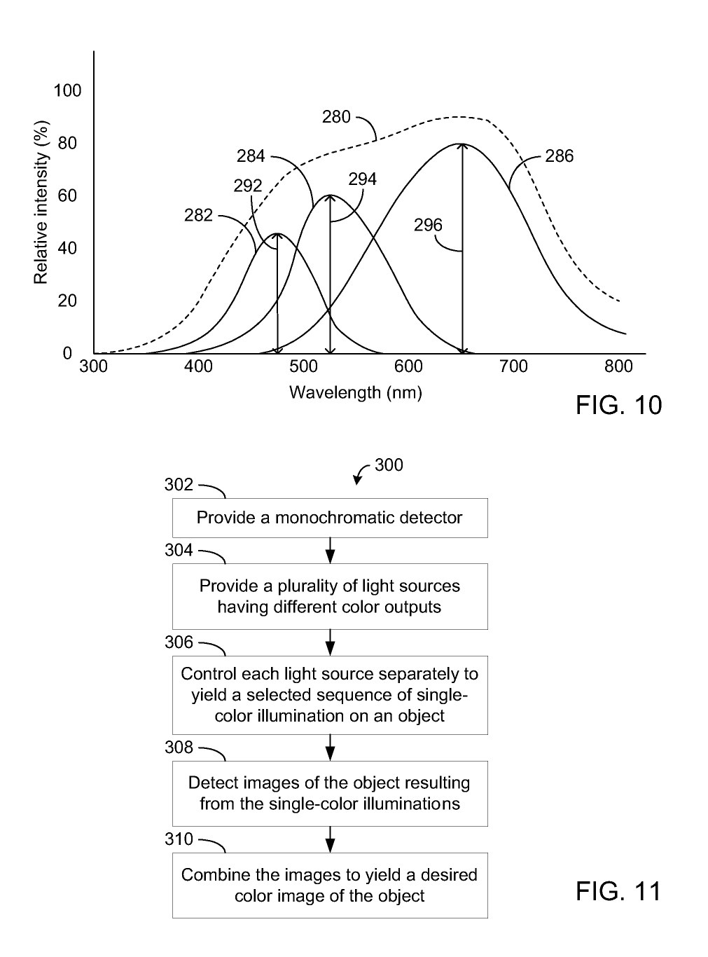

An example of such a selected light source is a Xenon light source that is used in many endoscopic applications. FIG. 10 shows a sketch of a typical Xenon bulb's intensity distribution 280. Also shown are sketches of intensity curves (286, 284, and 282) corresponding to the example red, green, and blue LEDs. The intensity curves 286, 284, and 282 are shown to have intensity amplitudes 296, 294, and 292, respectively. Thus, in certain embodiments, intensity amplitudes of the LEDs can be adjusted (e.g., via the controller and driver of FIG. 5) so as to yield a desired combined color distribution.

FIG. 11 shows a process 300 that can be implemented to achieve color imaging using a monochromatic detector. In a process block 302, a monochromatic detector can be provided. In a process block 304, a plurality of light sources having different color outputs can be provided. In a process block 306, the light sources can be controlled to yield a selected sequence of single-color illumination on an object to be imaged. In certain embodiments, each of the light sources can be controlled separately. In a process block 308, images of the object resulting from the single-color illumination can be detected. In a process block 310, the detected images can be combined to yield a desired color image of the object.

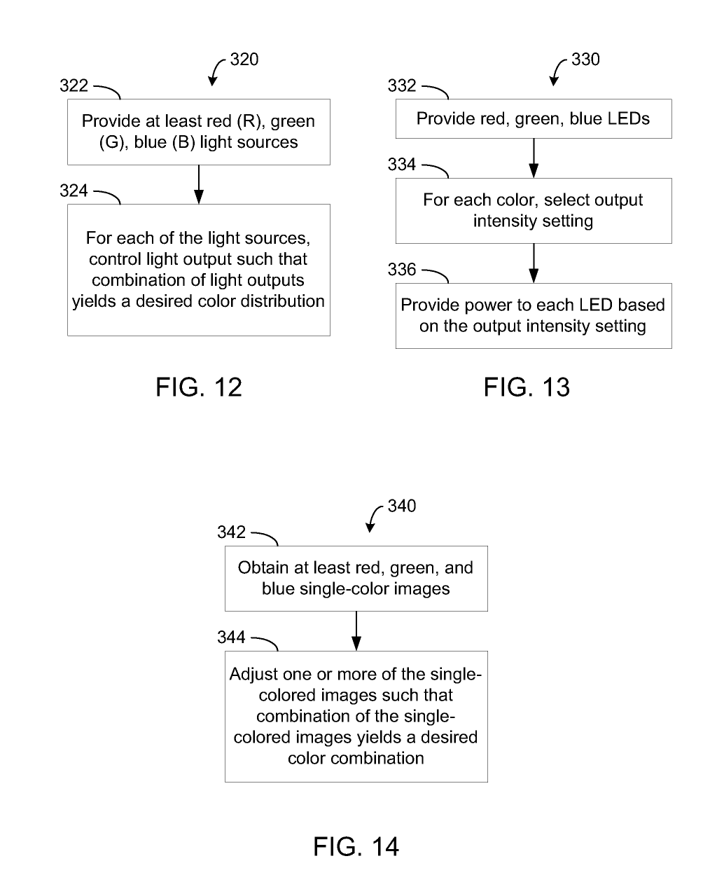

FIG. 12 shows a process 320 that can be implemented so as to obtain a desired combination of colors from single-color illumination. As described herein, such a combination can be selected to approximate a desired light source suitable for endoscopy applications.

In a process block 322, colored light sources including red, green, and blue colors can be provided. In a process block 324, each light source can be controlled so that its light output combines with outputs of other sources to yield a desired color combination.

FIG. 13 shows a process 330 that can be a more specific example of the process 320 of FIG. 12. In a process block 332, LEDs including red, green, and blue colors can be provided. In a process block 334, each LED can be controlled, and such a control can include selecting an output intensity. In a process block 336, power to each of the LED can be provided based on the selected intensity setting.

In certain embodiments, the process 330 of FIG. 13 can be implemented to achieve a combined color distribution such as the example Xenon distribution described in reference to FIG. 10. Other combined color distributions are also possible.

In FIGS. 6, 10, 12, and 13, a desired color effect or distribution can be obtained or approximated by controlling the detector's activation operations, or by adjusting one or more attributes of the colored light sources. In embodiments where detected signals are integrated, effective intensity of a given color can also be controlled by the corresponding source's activation pulse width, and/or by the detector's open-shutter duration. In certain situations, similar effects can also be obtained by performing adjustments during combination of the single-color images.

FIG. 14 shows a process 340 that can be implemented to perform such adjustments of single-color images. In a process block 342, single-color images such as red, green, and blue images can be obtained. In a process block 344, one or more of the single-color images can be adjusted such that combination of the adjusted images yields a desired color combination in the resulting color image.

In certain embodiments, various features of the present disclosure can be applied to some or all of endoscope illumination configurations described in a related U.S. application Ser. No. _______ (Attorney Docket INTEGR.008A) filed on even date herewith and which is incorporated herein by reference in its entirety.

In one or more example embodiments, the functions, methods, algorithms, techniques, and components described herein may be implemented in hardware, software, firmware (e.g., including code segments), or any combination thereof. If implemented in software, the functions may be stored on or transmitted over as one or more instructions or code on a computer-readable medium. Tables, data structures, formulas, and so forth may be stored on a computer-readable medium. Computer-readable media can be non-transitory, and can include both computer storage media and communication media including any medium that facilitates transfer of a computer program from one place to another. A storage medium may be any available medium that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

For a hardware implementation, one or more processing units at a transmitter and/or a receiver may be implemented within one or more computing devices including, but not limited to, application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a software implementation, the techniques described herein may be implemented with code segments (e.g., modules) that perform the functions described herein. The software codes may be stored in memory units and executed by processors. The memory unit may be implemented within the processor or external to the processor, in which case it can be communicatively coupled to the processor via various means as is known in the art. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Although the above-disclosed embodiments have shown, described, and pointed out the fundamental novel features of the invention as applied to the above-disclosed embodiments, it should be understood that various omissions, substitutions, and changes in the form of the detail of the devices, systems, and/or methods shown may be made by those skilled in the art without departing from the scope of the invention. Consequently, the scope of the invention should not be limited to the foregoing description, but should be defined by the appended claims.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

What is claimed is:

1. A method for operating an endoscope, comprising:
providing a plurality of different color light sources;
activating said different color light sources in sequence such that an object being imaged is provided with a sequence of different color illumination;
obtaining an image of said object during at least a portion of each of said sequence of different color illumination; and
combining said images so as to yield a combined image.

2. The method of claim 1, wherein said activating of said different color light sources comprises controlling one or more operating parameters of one or more of said color light sources such that a combination of lights from said color light sources yield a desired color distribution.

3. The method of claim 2, wherein said one or more operating parameters comprise intensity of light emission.

4. The method of claim 1, wherein said obtaining of said image comprises activation of a detector on which an optical image of said object is formed.

5. The method of claim 4, wherein duration of said detector activation is controllable for at least one color among said illumination so as to allow a combination of images having different color exposures to yield a desired color effect in said combined image.

6. The method of claim 4, wherein said detector comprises a monochromatic detector.

7. The method of claim 1, wherein combining of said images comprises adjusting at least some of said images so as to yield a desired color effect in said combined image.

8. The method of claim 1, wherein said color light sources comprise light-emitting diodes (LEDs), each LED configured to emit different color light.

9. An endoscope system, comprising:
a probe configured to be insertable into a body;
a plurality of light sources configured and disposed relative to said probe so as to provide a sequence of different color illumination from said probe to an object inside said body;
an assembly of optical elements configured and disposed relative to said probe so as to form images of said object during said sequence of different color illumination;
a detector configured to detect said images and generate signals representative of said detected images; and
a processor configured so as to control sequential activation of said plurality of light sources so as to yield said sequence of different color illumination.

10. The system of claim 9, wherein said processor is further configured so as to control said detector such that said images are detected sequentially.

11. The system of claim 10, wherein said sequential detection of said images is substantially synchronized with said sequential illumination.

12. The system of claim 9, wherein said plurality of light sources are disposed on said probe.

13. The system of claim 12, wherein said detector is disposed on said probe.

14. The system of claim 9, wherein said detector comprises a monochromatic detector.

15. The system of claim 9, wherein said plurality of light sources comprise light-emitting diodes (LEDs).

16. The system of claim 15, wherein said LEDs include at least red, green, and blue color emitting LEDs.

17. The system of claim 9, wherein said sequential activation of said light sources comprises application of periodic variations in power to each of said light sources so as to yield said sequence of different color illumination.
